(19) United States
(12) Patent Application Publication
(10) Pub. No.: US 2009/0229470 A1
(43) Pub. Date: Sep. 17, 2009

(54) Coffee Cartridge Lid Apparatus and Method

(75) Inventor: David D. Dorfmueller, Madison, AL (US)

Correspondence Address: LANIER FORD SHAVER & PAYNE P.C., P O BOX 2087, HUNTSVILLE, AL, 35804-2087, US

(73) Assignee: My-Kap, LLC, Madison, AL (US)

(21) Appl. No.: 12/403,242

(22) Filed: Mar. 12, 2009

Related U.S. Application Data
(60) Provisional application No. 61/036,038, filed on Mar. 12, 2008.

(51) Int. Cl. A47J 31/40

(52) U.S. Cl. 99/295; 426/77; 426/433

(57) ABSTRACT

A disc for mating with a single-serving coffee filter cartridge is provided. The disc has double-beveled peripheral edge that extends from a first side of the disc to a transition point at a first angle and extends at a second angle from the transition point to a second side of the disc. An aperture in the disc receives liquid when the single serving coffee filter cartridge is inserted in a coffee maker.

### REFERENCE TO RELATED APPLICATIONS

This application claims priority to U.S. Provisional Patent Application No. 61/036,038, filed Mar. 12, 2008, titled “The Cap for re-using Coffee Pods, K-Cups, and T-Disks,” which is incorporated by reference herein in its entirety,

### FIELD OF THE INVENTION

The present invention relates generally to the field of electric coffee makers, and more specifically to an apparatus and method for reusing single-serving coffee filter cartridges.

### BACKGROUND AND SUMMARY OF THE INVENTION

An apparatus and method for reusing single-serving coffee filter cartridges is provided. The apparatus comprises a lid that allows a disposable single-serving coffee filter cartridge to be reused. A single-serving coffee filter cartridge houses coffee grounds, tea leaves or other granular or powdered dry beverage medium, for brewing in a single-serving coffee maker. A single-serving coffee maker is a coffee maker that brews generally one serving of coffee at a time, and generally dispenses the coffee directly into a coffee cup. Some single-serving coffee makers use prefilled filter cartridges of the type disclosed in U.S. Pat. No. 6,645,537 (“Beverage Filter Cartridge”). This type of cartridge is comprised of an impermeable cup-shaped outer container that houses a filter and is prefilled with ground coffee, for example. The cartridge has a pierceable cover that is sealed to the outer container.

In order to brew coffee, a user inserts the cartridge into the coffee maker and

closes the lid. When the lid is closed, the inlet and outlet probes of the coffee maker pierce the lid and container bottom, respectively. The inlet probe admits heated liquid under pressure into the container. The liquid is infused with the coffee and then passes through the filter and exits via the outlet probe for delivery into a coffee cup. The cartridges are intended to be disposed of after a single use.

A lid according to the present disclosure allows the user to reuse the coffee

cartridges. In order to reuse the cartridge, the user removes it from the coffee maker and peels off the lid to remove it from the container. The user then empties the used grounds from the container, washes it, and refills it with fresh grounds. The user should let the filter dry before refilling it with coffee grounds unless the filter will be used immediately, to maintain the cleanliness of the filter. A disc-shaped, reusable lid is then installed in the top of the container. The lid fits within the opening of the container in a tight friction fit, and has an opening for receiving the liquid for brewing coffee or other brewed beverage. The tight friction fit between the lid and the cartridge enables the cartridge to receive hot pressurized liquid during brewing without leaking around the perimeter of the lid.

### BRIEF DESCRIPTION OF THE DRAWINGS

The present invention is described with reference to the accompanying drawings. In the drawings, like reference numbers indicate identical or functionally similar elements.

FIG. 1 is a perspective view of a single-serving coffee filter cartridge that is known in the art.

FIG. 2 is cross-sectional view of the prior art coffee filter cartridge of FIG. 1, taken along section lines “A-A” of FIG. 1.

FIG. 3 is perspective view of a lidded cup according to an embodiment of the present disclosure.

FIG. 4 is a side plan view of the lid of FIG. 3.

FIG. 5 is an enlarged detail view of the lid of FIG. 3, taken along detail line “B” of FIG. 4

FIG. 6 is a top plan view of the lid of FIG. 3.

FIG. 7 is a top plan view of an alternative embodiment of the lid.

FIG. 8 is a cross-sectional view of the lid of FIG. 7, taken along section lines “C-C” of FIG. 7.

FIG. 9 is a bottom plan view of the lid of FIG. 7.

FIG. 10 is a top perspective view of the lid of FIG. 7.

FIG. 11 is a side plan view of an extraction tool according to an embodiment of the present disclosure.

FIG. 12 is a flowchart showing a method of reusing a cartridge according to an embodiment of the present disclosure.

### DETAILED DESCRIPTION

The present invention and its advantages are best understood by referring to the

drawings. The elements of the drawings are not necessarily to scale, emphasis instead being placed upon clearly illustrating the principles of the invention.

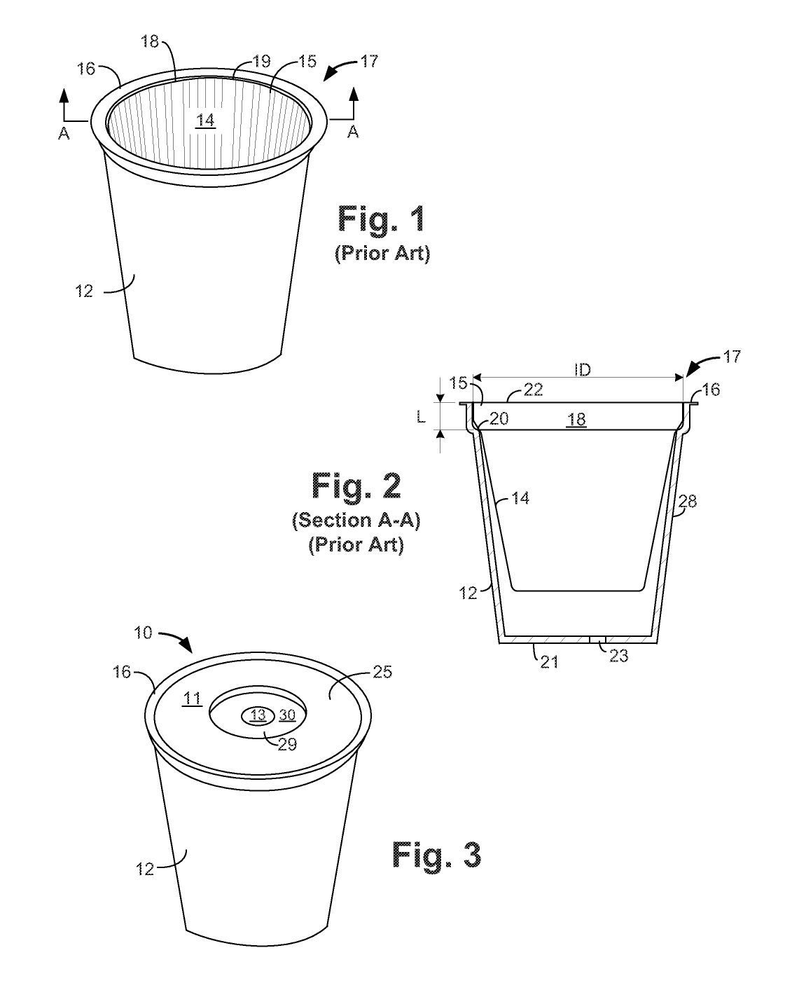

FIG. 1 depicts a single-serving coffee filter cartridge 17 that is known in the art. The cartridge 17 comprises a cup-shaped outer container 12 that houses a filter 14 for containing granular or powdered dry beverage medium (not shown), coffee grounds, for example. The term “coffee grounds” as used herein will refer to any such granular or powdered dry beverage medium, regardless of whether such beverage medium is coffee, tea, hot cocoa mix, or any other such granular or powdered dry beverage medium. Further, the term “single-serving coffee cartridge” as used herein will refer to a cartridge for housing any type of granular or powdered dry beverage medium.

The container 12 has an upper opening 15 bounded by an upper side wall 18 and a rim 16. The upper side wall 18 extends downwardly from the rim 16. The upper side wail 18 is substantially cylindrical in the illustrated embodiment. The container 12 is generally formed of yieldable pierceable material, such as polyethylene, or other suitable material.

The filter 14 is formed from a pliable material and has a pleated upper edge 19 that is adhered to the upper side wall 18. The pleated upper edge of the filter is generally not a smooth or regular surface.

FIG. 2 is a cross-sectional view of the prior art coffee filter cartridge 17 of FIG. 1, taken along section lines A-A. The rim 16 of the container 12 bounds the upper opening 15 and extends radially from the upper opening 15. The upper side wall 18 extends downwardly from the upper opening 15 and tapers in at a shoulder 20. In the illustrated embodiment, the upper side wall 18 is generally cylindrical until it tapers in at the shoulder 20.

In one configuration of the container 12, an inner diameter “ID” measured at a top edge 22 of the upper side wall 18 is 1.73 inches. Other configurations of the container may have a differently-dimensioned inner diameter.

A lower side wall 28 extends down from the shoulder 20 to a bottom 21 of the container 12. The filter 14 is adhered to the upper side wall 18.

In one configuration of the container 12, the distance “L” between the top edge 22 of the container 12 and the shoulder 20 is 0.20 inches, though other dimensions are used in other configurations. Further, some configurations of the container 12 may not have a shoulder 20 at all, but may rather have a side wall 18 that tapers uniformly from the top edge 22 to the bottom 21, or may be otherwise configured.

When a user (not shown) purchases a commercially-available coffee filter cartridge 17, the filter 14 is filled with coffee grounds (not shown) and a pierceable cover (not shown) covers the upper opening 15 and is adhered to the rim 16. The pierceable cover is pierced in its center by an inlet probe (not shown) during the brewing process. In the illustration, however, the cover and the coffee grounds have been removed by the user so that the cartridge 17 may be reused.

A bottom opening 23 is created in the bottom 21 of the container 12 when the cartridge 17 is used to brew a beverage (not shown). Brewed beverage (not shown) exits the container 12 through the bottom opening 23 during the brewing process.

FIG. 3 depicts an embodiment of a lidded cup 10 according to the present disclosure. The lidded cup 10 comprises a container 12 of the type discussed above and a lid 11. The lid 11 is an integrally-formed, generally circular disc that is insertable into the upper opening 15 (FIG. 1) of the container 12. The lid 11 is molded from rigid plastic in one embodiment, but is formed from other suitable materials in other embodiments.

The lid 11 comprises a recession 29 recessed into a top side 25 of the lid 11. The recession 29 is generally cylindrical in shape and has a top sealing surface 30. The recession 29 is centrally located in the lid 11 and comprises an aperture 13 centrally located within the recession 29. The aperture 13 is a generally cylindrical opening that extends through the lid 11, as further discussed herein.

When the lidded cup 10 is in use to brew a beverage, the lidded cup 10 is installed into a coffee maker (not shown) and the coffee maker is closed. When the coffee maker is closed, its inlet probe (not shown) extends into the aperture 13 and a gasket (not shown) surrounding the inlet probe seals against the sealing surface 30 of the recession 29. Pressurized hot liquid (not shown) is injected into the container 12 by the coffee maker through the aperture 13.

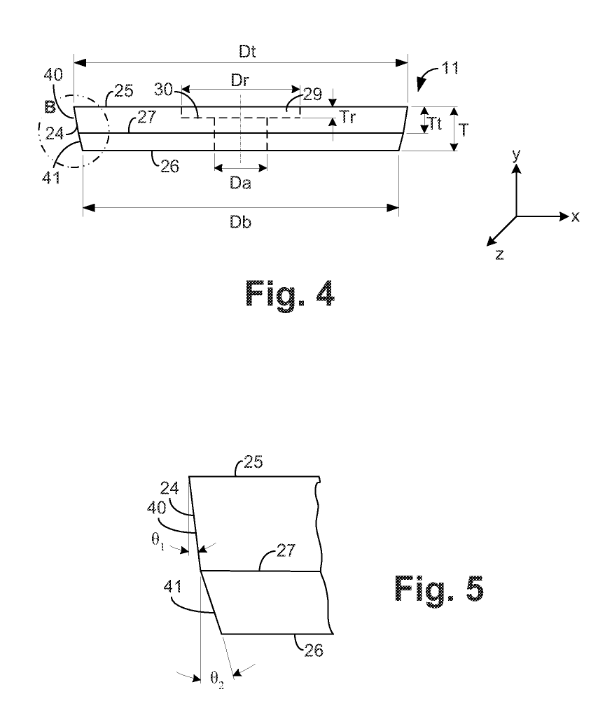

FIG. 4 is a side plan view of the lid 11 of FIG. 3. The lid 11 is a generally circular disc with a beveled peripheral edge 24 that extends from a top side 25 of the lid 11 to a bottom side 26 of the lid 11.

In this embodiment, the peripheral edge 24 is “double beveled,” meaning that it comprises a first beveled surface 40 that extends downwardly from the top side 24 at a first angle θ₁ (FIG. 5) to a transition point 27 and also has a second beveled surface 41 that extends downwardly at a second angle θ₂ (FIG. 5) from the transition point 27 to the bottom side 26. The term “transition point” refers to the location where the first angle θ₁ meets the second angle θ₂.

The purpose of this double beveling of the peripheral edge 24 is to enable a tight friction fit between the lid 11 and the upper opening 15 (FIG. 1), as further discussed herein. In some embodiments, however, there may be a single bevel (not shown) to the peripheral edge 24, i.e., the peripheral edge 24 may taper uniformly from the top side 25 to the bottom side 26. Further, in other embodiments the peripheral edge 24 may be straight from the top side 25 to the bottom side 26.

In one embodiment, the thickness “T” of the lid 11 (i.e., the distance in the y direction between the top side 25 and the bottom side 26) is substantially 0.23 inches. Further, in one embodiment the distance “Tt” in the y direction between the top side 25 and the transition point 27 is 0.14 inches. In other embodiments T and Tt are differently-dimensioned.

The diameter of the lid 11 at the top edge 25, “Dt,” is 1,757 inches in one embodiment of the lid 11. In another embodiment, Dt is within the range of 1.752 and 1.762 inches. The diameter of the lid at the bottom edge 26, “Db,” is 1.70 inches in one embodiment. In other embodiments, Dt and Db may be differently-dimensioned.

The recession 29 has a diameter “Dr” of 0.772 in one embodiment, and in other embodiments is differently-dimensioned. The recession 29 has a depth “Tr” of 0.08 in one embodiment. It is important to the operation of the lid in brewing beverages that the sealing surface 30 be lower than the top edge 22 of the container 12. In one embodiment, the sealing surface 30 is between 0.01 inches and 0.10 inches beneath the top edge 22 of the container for proper operation of the lid 11. Note that the location of the sealing surface 30 with respect to the top edge 22 of the container is dependent on the diameter of the lid 11, and therefore the relationship between the lid diameter and the location of the sealing surface should be considered when sizing and configuring embodiments of the lid 11.

The aperture 13 has a diameter “Da” of 0.219 in one embodiment, and in another embodiment the diameter Da tapers uniformly from a diameter of 0.219 at the sealing surface 30 to a diameter of 0.250 at the bottom side 26. Other embodiments of the lid 11 have different dimensions for Dr, Tr, and Da.

The sealing surface 30 of the recession 29 is generally flat and generally smooth so that the gasket (not shown) of the coffee maker (not shown) may seal against it without leaking during the brewing process.

FIG. 5 is an enlarged detail view of the lid 11 of FIG. 4, taken along detail line “B” of FIG. 4. As discussed above, the first bevel 40 extends at the first angle θ₁ from the top side 25 to the transition point 27, and the second bevel 41 extends at the second angle θ₂ from the transition point 27 to the bottom side 26. In one embodiment, the first angle θ₁ is substantially 5 degrees and the second angle θ₂ is substantially 10 degrees, i.e., the first angle θ₁ is two times the second angle θ₂. In other embodiments, other dimensions may be used for the first angle θ₁ and the second angle θ₂. Note that the angles θ₁ and θ₂ are shown and measured from the y axis, and not from the top side 25 of the lid 11, which would be in the x-z plane.

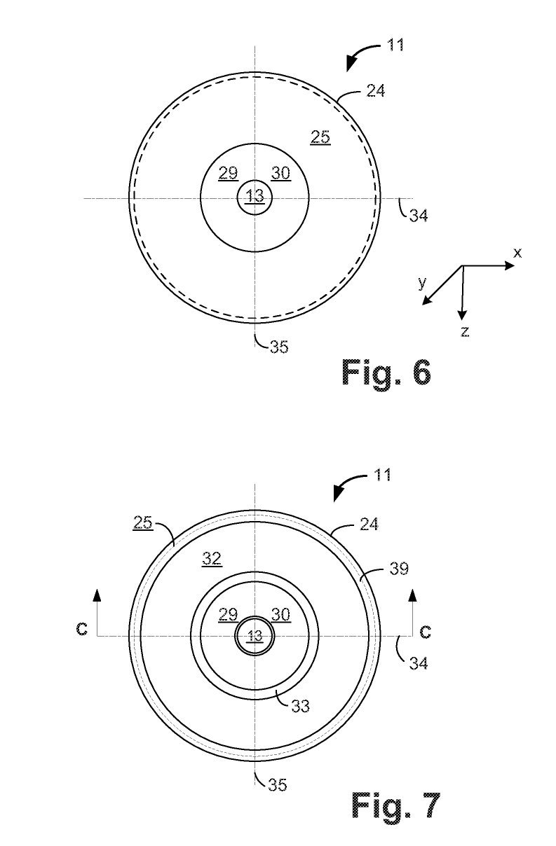

FIG. 6 is a top plan view of the lid 11 of FIG. 3. In this embodiment, the lid 11 is symmetrical about its x and y axes, 34 and 35, respectively. The top side 25 is generally flat and extends generally uniformly from the peripheral edge 24, then “steps down” at the recession 29 of the lid 11.

FIG. 7 is a top plan view of another embodiment of the lid 11. In this

embodiment, the top side 25 is not generally flat, but rather the top side 25 has an outer ridge 39 along the top side 25 where the top side 25 meets the peripheral edge 24, and then “steps down” to a top channel 32 that is recessed into the top side 25 of the lid 11. An inner ridge 33 surrounds the recession 29 and extends upwardly from the top channel 32.

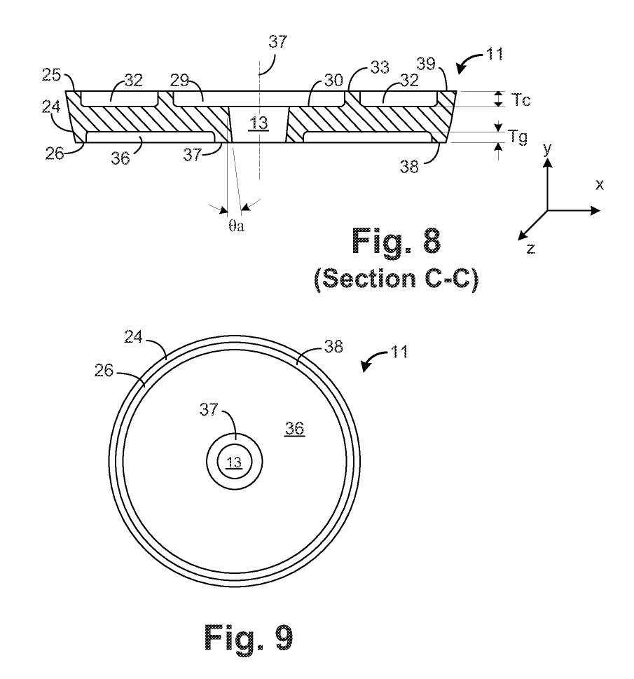

FIG. 8 is a cross-sectional view of the embodiment of FIG. 7, taken along section

lines “C-C” of FIG. 7. The outer ridge 39 extends from the peripheral edge 34 inwardly a short distance, and then steps down to the top channel 32. The outer ridge 39 is at the same level as the top side 25 in the illustrated embodiment. In one embodiment the outer ridge 39 is 0.074 wide, though is differently-dimensioned in other embodiments.

The depth “Tc” of the top channel 32 is 0.08 in one embodiment and the top channel 32 has a width of approximately 0.36 inches in one embodiment. The top channel 32 extends uniformly around the y axis 37 of the disk 11, as illustrated. The inner ridge 33 extends upwardly from the top channel 32 and has a width of 0.06 in one embodiment. The recession 29 and the sealing surface 30 are configured as described above with respect to FIGS. 3 & 4.

The aperture 13 extends through the lid 11 from the sealing surface 30 to the bottom side 26. In this embodiment, the aperture 13 tapers inwardly from the sealing surface 30 to the bottom side 26 at an angle “θa” of 6 degrees, and in one embodiment the aperture 13 has a diameter of 0.25 measured at the sealing surface 30 and 0.219 measured at the bottom side 26. In other embodiments, the aperture 13 may be differently tapered and differently dimensioned. Further, the aperture 13 may not be tapered at all, but may be cylindrically-shaped.

The bottom side 26 has a bottom ridge 38 that extends from the peripheral edge 34 a short distance, then steps up to a bottom channel 36. The depth “Tg” of the bottom channel 36 is 0.045 in one embodiment. The bottom channel 36 extends uniformly around the y axis 37 of the disk 11, as illustrated.

The bottom side 26 further comprises an inner bottom ridge 37 that extends

upward from the bottom channel 36.

FIG. 9 is a bottom plan view of the lid 11 of FIG. 7. The peripheral edge 24 is tapered in the manner discussed above with respect to FIGS. 4 and 5. The bottom side 26 comprises a bottom ridge 38 that extends from the peripheral edge inwardly. The bottom channel 36 extends from the bottom ridge 38 to the inner bottom ridge 37. The inner bottom ridge 37 bounds the aperture 13.

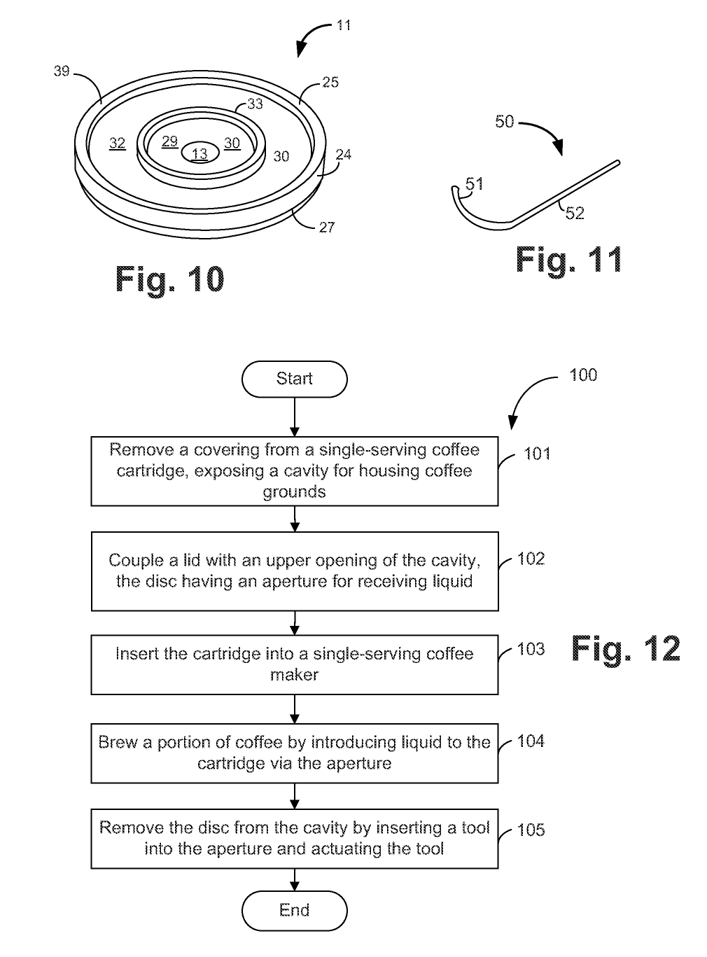

FIG. 10 is a top perspective view of the lid 11 of FIG. 1. The top channel 32 is recessed into the top side 25 of the lid 11. The outer ridge 39 extends from the top surface inwardly. The inner ridge 33 extends upwardly from the top channel 32. The aperture 13 is centrally located within the recession 29. The peripheral edge 24 extends from the top side 25 to the bottom side (not shown) and is double-beveled as discussed above. The transition point 27 is the boundary between the two bevils of the peripheral edge 24.

FIG. 11 depicts an extraction tool 50 according to an embodiment of the present disclosure. The extraction tool 50 is insertable into the aperture 13 (FIG. 3) and is actuatable to remove the lid 11 (FIG. 3) from the upper opening 15 (FIG. 1). The tool 50 comprises a hook portion 51 and a handle portion 52. The user (not shown) may grasp the handle portion 52 and insert the hook portion 51 into the aperture 13 and actuate the tool to remove the lid 11. The hook portion 51 is sized to be insertable into the aperture. Other configurations of extraction tools 50 are used in other embodiments to remove the lid 11.

FIG. 12 is a flowchart showing a method 100 for reusing single-serving coffee filter cartridges 17 (FIG. 1) according to an embodiment of the disclosure. In step 101, the user (not shown), removes the covering from the single-serving coffee cartridge 17, exposing the cavity (not shown) in which coffee grounds (not shown) are housed. The user may then clean out the coffee grounds and wash the container 12 (FIG. 1) in preparation for its reuse.

In step 102, the user then couples the lid 11 (FIG. 3) with the upper opening 15 (FIG. 1) of the cavity by inserting the lid 11 into the upper opening 15. The double beveled peripheral edge 24 (FIGS. 4 & 5) allows the lid 11 to achieve a tight friction fit into the upper opening 15. In this regard, the larger angle θ₂ of the second bevel 41 (FIG. 5) compresses the pleated upper edge 19 (FIG. 1) of the filter 14 as the lid 11 enters the upper opening 15. Then, as the lid 11 further enters the upper opening 15, the first bevel 40 with its smaller angle θ₁ causes a tight fit of the lid 11 in the upper opening 15. Note that in one embodiment, the lid 11 does not have to be recessed completely within the upper opening 15 in order to be properly sealed, but may protrude from the upper opening 15 slightly, though not so far as to interfere with the operation of the coffee maker.

Further, in some embodiments the lower bevel 41 (FIG. 4) or the bottom side 26 may contact the shoulder 20 (FIG. 2) when the lid 11 is fully inserted into the upper opening 15. However, in other embodiments, the lower bevel 41 and the bottom side 26 do not contact, or “bottom out” on, the shoulder at all. Rather, the tight friction fit between the peripheral edge 24 and the upper side wall 18 restrains the lid 11 within the upper opening 15.

Note that the container 12 is generally somewhat flexible, and this flexibility helps to ensure a tight fit between the lid 11 and the upper opening 15.

In step 103, the user inserts the cartridge 17 into a single-serving coffee maker (not shown), and then in step 104, the user brews a single-serving portion of coffee by introducing liquid (not shown) into the cartridge 17 via the aperture 13.

After the coffee maker has completed the brewing cycle, the user may remove the cartridge 17 from the coffee maker and then, in step 105, may remove the lid 11 from the upper opening 15 by inserting a tool (not shown) into the aperture 13 and actuating the tool. The tool may be any device with an extension that is insertable into the aperture 13 and may be used to “hook” the aperture and remove the lid 11 from the upper opening 15.

This invention may be provided in other specific forms and embodiments without departing from the essential characteristics as described herein. The embodiment described is to be considered in all aspects as illustrative only and not restrictive in any manner.

As described above and shown in the associated drawings and exhibits, the present invention comprises system and method for reusing a single-serving coffee refill. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. An apparatus, comprising:
a disc for mating with a single serving coffee filter container, the disc having a peripheral edge that extends from a first side of the disc to a transition point at a first angle and extends at a second angle from the transition point to a second side of the disc; and
an aperture in the disc for receiving water when the single serving coffee filter container is inserted in a coffee maker.

2. The apparatus of claim 1, wherein the second angle is two times the first angle.

3. The apparatus of claim 1, wherein the first angle is approximately five degrees.

4. The apparatus of claim 3, wherein the second angle is approximately ten degrees.

5. The apparatus of claim 1, wherein the disc is for insertion into a cavity of the single serving coffee filter container.

6. The apparatus of claim 5, wherein the cavity is substantially cylindrical.

7. The apparatus of claim 6, wherein the first angle of the peripheral edge frictionally couples to the cavity.

8. The apparatus of claim 1, wherein the peripheral edge is within the range of 1.752 and 1.762 inches in diameter.

9. The apparatus claim of 1, wherein the disc is for insertion into a receptacle of the single serving coffee filter container and the receptacle is approximately 1.73 inches in diameter.

10. An apparatus, comprising:
a disc:
a first peripheral edge of the disc having a first angle, the first peripheral edge extending from a first side of the disc;
a second peripheral edge of the disc integral with the first peripheral edge and having a second angle, the second peripheral edge extending from the first peripheral edge to a second side of the disc; and
an aperture in the disc for receiving water when the single serving coffee filter container is inserted in a coffee maker.

11. The apparatus of claim 10, wherein the disc comprises an aperture substantially centrally located on the disc.

12. The apparatus of claim 10, wherein the second angle is two times the first angle.

13. The apparatus of claim 10, wherein the first angle is substantially five degrees.

14. The apparatus of claim 10, wherein the second angle is substantially ten degrees.

15. An apparatus, comprising:
a disc having a peripheral edge that gradually decreases in diameter from a first side to a second side, the disc for insertion into a single serving coffee filter container;
an aperture within the disc for receiving water when the single serving coffee filter container is inserted in a coffee maker.

16. A method, comprising:
removing a covering from a single serving coffee filter container, the single serving coffee filter container comprising a cavity for housing coffee grounds;
coupling a disc with an upper portion of the cavity, thereby retaining the coffee grounds within the cavity, the disc having an aperture for receiving liquid;
inserting the coffee filter container coupled with the disc into a coffee machine;
brewing a cup of coffee by introducing liquid to the coffee filter cup via the aperture in the disc that is coupled to the cavity; and
removing the disc from the coffee filter cup by inserting a tool into the aperture and actuating the tool.
